(19) United States
(12) Patent Application Publication
(10) Pub. No.: US 2012/0025935 A1
(43) Pub. Date: Feb. 2, 2012

(54) MAGNETIC SWITCH APPARATUS

(75) Inventor: JIN-SHI LAI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/871,840

(22) Filed: Aug. 30, 2010

(30) Foreign Application Priority Data
Jul. 30, 2010 (CN) 201010241295.3

(51) Int. Cl. H01H 36/00; H01H 13/50; H01H 13/02

(52) U.S. Cl. 335/205

(57) ABSTRACT

A magnetic switch apparatus includes a button and a magnetic mechanism. The button is capable of moving between a first position and a second position. The magnetic mechanism is configured to drive the button to be kept in the first position, and drive the button to move from the second position to the first position.

### BACKGROUND

1. Technical Field

The present disclosure relates to switch apparatuses and, particularly, to a magnetic switch apparatus.

2. Description of Related Art

Conventionally, a push switch includes a coil spring to urge a button to a normal position. After repeated use, the elasticity of the spring may decrease or the spring may break, which may result in switch failure.

### BRIEF DESCRIPTION OF THE DRAWINGS

The components of the drawings are not necessarily drawn to scale, the emphasis instead being placed upon clearly illustrating the principles of a switch apparatus. Moreover, in the drawings, like reference numerals designate corresponding parts throughout several views.

FIG. 1 is an isometric view of a switch apparatus in accordance with an exemplary embodiment.

FIG. 2 is an exploded, perspective view of the switch apparatus of FIG. 1.

FIG. 3 is a partially exploded, perspective view of the switch apparatus of FIG. 1, showing the switch apparatus in an electrically open state.

FIG. 4 is similar to FIG. 3, but showing the switch apparatus in an electrically closed state.

### DETAILED DESCRIPTION

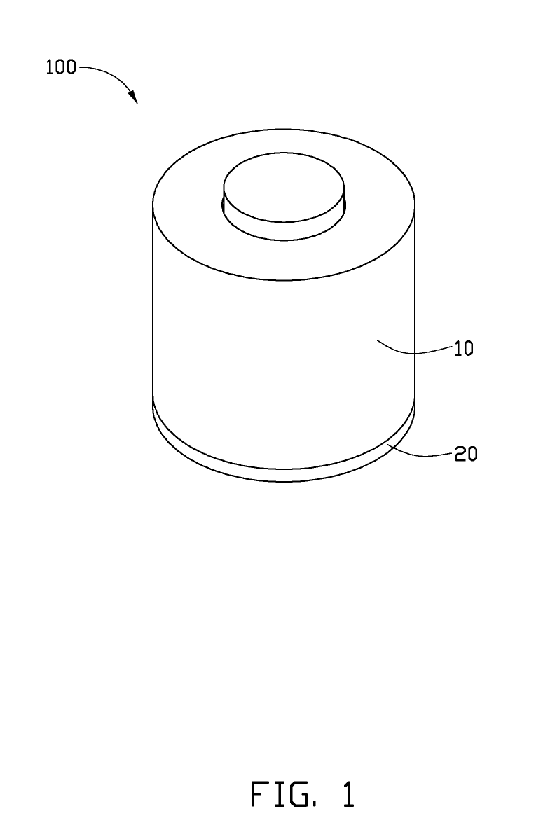

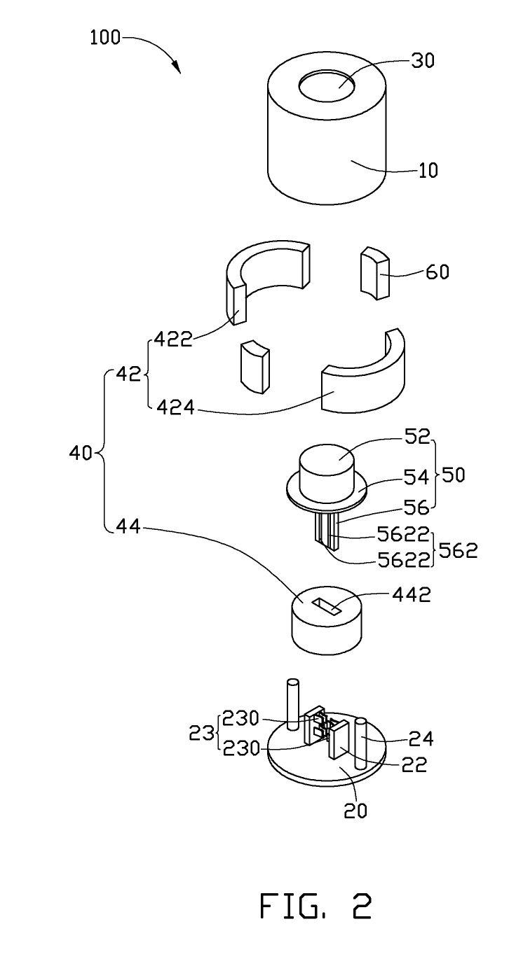

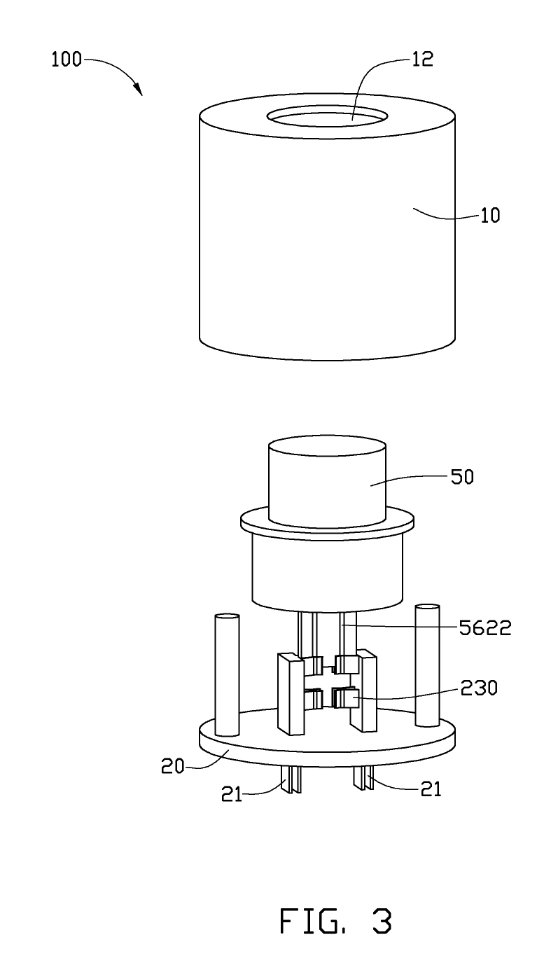

Referring to FIGS. 1-3, a switch apparatus 100 includes a main body 10 and a base 20 secured to the main body 10. The main body 10 and the base 20 cooperatively form a receiving space 30. The switch apparatus 100 further includes a magnetic mechanism 40 and a button 50 received in the receiving space 30. The button 50 can be driven to move in the receiving space 30 between a first position and a second position. The button 50 can be driven to move from the first position to the second position by an external force, and can be driven to move from the second position to the first position by the magnetic force of the magnetic mechanism 40. The button 50 can be further driven to keep in the first position by the magnetic force of the magnetic mechanism 40. In this embodiment, when the button 50 is in the first position, the switch apparatus 100 is in an electrically open state, and when the button 50 is in the second position, the switch apparatus 100 is in an electrically closed state.

In this embodiment, the main body 10 is substantially a hollow cylinder. The shape of the main body 10 can vary according to need. An end of the main body 10 opposite to the base 20 defines a through hole 12.

In this embodiment, the base 20 is substantially disc-shaped. The diameter of the base 20 is substantially equal to that of the main body 10. The shape of the base 20 can vary according to need. The base 20 includes two conductive terminals 21 external to the receiving space 30 and spaced apart from each other. Two projections 22 protrude from a surface of the base 20 and are received in the receiving space 30. A pair of first conductive elements 23 respectively protrudes perpendicularly from the projections 22 towards each other. Each first conductive element 23 connects to one conductive terminal 21. In this embodiment, each first conductive element 23 includes two spaced vertically-aligned sub-conductive elements 230. Each sub-conductive element 230 includes two conductive sheets (not labeled) spaced from each other. Two supports 24 further protrude from the base 20 and are received in the receiving space 30. The projections 22 are arranged between the supports 24.

In this embodiment, the magnetic mechanism 40 includes a magnet member 42 and an iron block 44. The magnet member 42 is secured to the sidewall of the receiving space 30, and the iron block 44 is secured to a distal end of the button 50. The arrangement of the magnet member 42 and the iron block 44 may vary according to need. For example, the magnet member 42 may be secured to the distal end of the button 50, and the iron block 44 may be secured to the sidewall of the receiving space 30. In an alternative embodiment, two magnet members may be employed, one is secured to the sidewall of the receiving space 30, and the other one is secured to the distal end of the button 50. In this embodiment, the magnet member 42 includes two magnets 422 and 424. The magnets 422 and 424 are substantially semi-annular. The magnet member 42 may vary according to need. For example, the magnet member 42 may be an annular magnet. The magnets 422 and 424 are secured to the sidewall of the receiving space 30 and spaced from each other due to two insulated positioning blocks 60 and the supports 24. The magnets 422 and 424 can be secured to the sidewall of the receiving space 30 through other ways. For example, the sidewall of the receiving space 30 may define recessed portions to secure the magnets 422 and 424. The south pole of the magnet 422 is aligned across the space with the north pole of the magnet 424. In order to prolong the lifetime of the switch apparatus 100, it is better to use permanent magnets.

The iron block 44 defines a through hole 442 along an axis of the iron block 44. In this embodiment, the through hole 442 is substantially rectangular. The width of the through hole 442 is substantially equal to the distance between the projections 22. The surface of the through hole 442 may be coated for insulation.

The button 50 includes a pressing member 52, a fixing member 54, and a connecting member 56. The diameter of the pressing member 52 is substantially equal to that of the through hole 12, so the pressing member 52 can extend through the through hole 12 and slide along an axis of the main body 10 when pressure is applied. The pressing member 52 may be made of insulated material. The shape of the connecting member 56 is the same as the through hole 442, and the height of the connecting member 56 is greater than the depth of the through hole 442, so the connecting member 56 can extend through and be exposed to the through hole 442. After the connecting member 56 extends through the through hole 442, the iron block 44 is secured to the fixing member 54. The connecting member 56 includes a trigger portion 562 corresponding to the first conductive elements 23. In this embodiment, the trigger portion 562 includes two second conductive elements 5622 spaced apart from and connected to each other, and each conductive element 5622 is a bar-shaped conductive sheet.

In this embodiment, normally, the button 50 is kept in the first position due to the magnetic force of the magnetic mechanism 40. When in the first position, the connecting member 56 does not insert into the sub-conductive elements 230, the second conductive elements 5622 do not contact the sub-conductive elements 230, and the conductive terminals 21 are in a disconnected state, thus the switch apparatus 100 is in the open state.

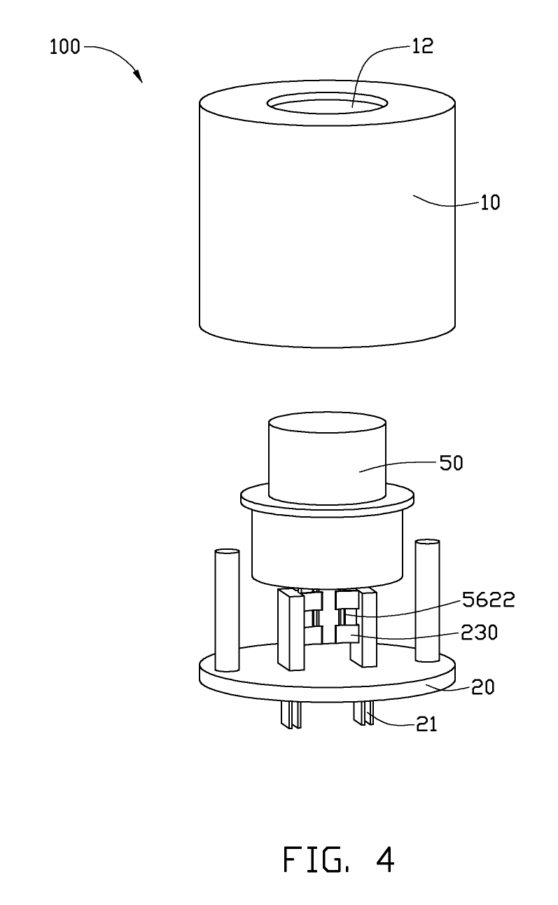

Referring to FIG. 4, if the pressing member 52 is depressed, the button 50 is driven to move toward the base 20 along the axis of the main body 10 until the connecting member 56 inserts into the sub-conductive elements 230. When the connecting member 56 inserts into the sub-conductive elements 230, the second conductive elements 5622 contact the sub-conductive elements 230, thus the conductive terminals 21 are electrically connected, and the switch apparatus 100 is in the closed state. When the pressing member 52 is released, the button 50 is driven to move along an opposite direction to the base 20 by the magnetic force of the magnetic mechanism 40 until the button 50 returns to the first position.

With such configuration, as the magnetism of the magnetic mechanism 40 is not easily weakened, the lifetime of the switch apparatus 100 may be prolonged.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A magnetic switch apparatus, comprising:
a button capable of moving between a first position and a second position; and
a magnetic mechanism configured to drive the button to be kept in the first position, and drive the button to move from the second position to the first position.

2. The magnetic switch apparatus as described in claim 1 further comprising a main body, wherein the button is received in the main body.

3. The magnetic switch apparatus as described in claim 2, wherein the magnetic mechanism comprises a magnet member and an iron member, the magnet member is secured to the main body, and the iron member is secured to the button.

4. The magnetic switch apparatus as described in claim 2, wherein the magnetic mechanism comprises a magnet member and an iron member, the magnet member is secured to the button, and the iron member is secured to the main body.

5. The magnetic switch apparatus as described in claim 2, wherein the magnetic mechanism comprises two magnet members, one of the magnet members is secured to the main body, and the other one of the magnet members is secured to the button.

6. The magnetic switch apparatus as described in claim 2, further comprising a base secured to the main body, wherein the button comprises a trigger portion, the base comprising two conductive terminals, when the button is driven to move from the first position to the second position by an external force, the trigger portion connects to the conductive terminals to cause the conductive terminals to be electrically connected, the switch apparatus is thus in a closed state, and when the button is released, the button is driven to move from the second position to the first position by the magnetic force of the magnet mechanism.

7. The magnetic switch apparatus as described in claim 6, wherein the base comprises two first conductive elements, each of the first conductive elements is connected to one of the conductive terminals, the trigger portion comprises two second conductive elements connecting to each other, when the button is moved to the second position, each of the second conductive elements contacts one of the first conductive elements, causing the conductive terminals to be electrically connected.

8. The magnetic switch apparatus as described in claim 6, wherein the first conductive elements and the second conductive elements are conductive sheets.

9. The magnetic switch apparatus as described in claim 2, wherein the main body defines a through hole, the button comprises a pressing member, the pressing member is operable by the through hole, and is able to move along an axis of the main body.

10. The magnetic switch apparatus as described in claim 1, wherein when the button is in the first position, the switch apparatus is in an electrically open state, and when the button is in the second position, the switch apparatus is in an electrically closed state.
